(19) United States
(12) Patent Application Publication
(10) Pub. No.: US 2026/0191733 A1
(43) Pub. Date: Jul. 9, 2026

(54) Wall Mount Roller Hack Squat

(71) Applicant: The Cobra System LLC, West Mifflin, PA (US)

(72) Inventor: Timothy V. Taylor, Canonsburg, PA (US)

(21) Appl. No.: 19/443,810

(22) Filed: Jan. 8, 2026

Related U.S. Application Data
(60) Provisional application No. 63/833,713, filed on Jan. 8, 2025.

(51) Int. Cl. A61H 15/00; A61H 23/02

(52) U.S. Cl. CPC A61H 15/0085; A61H 23/02; A61H 2015/0014; A61H 2015/0071; A61H 2201/0126; A61H 2201/1215

(57) ABSTRACT

A wall mounted roller device, having a roller having a body with an external surface circumferentially around an elongated bar, the bar having at least two attachment ends; and a base having a top sidewall, a bottom sidewall, and at least two parallel guide rails connected to the top sidewall and the bottom sidewall, the at least two parallel guide rails each having a plurality of attachment points; where the plurality of attachment points of the at least two parallel guide rails are configured to receive the at least two attachment ends of the bar such that the body of the roller is perpendicular to the at least two parallel guide rails.

### CROSS REFERENCE TO RELATED APPLICATION

This application claims priority to U.S. Provisional Application No. 63/833,713, filed on Jan. 8, 2025, the disclosure of which is hereby incorporated by reference in its entirety.

### BACKGROUND OF THE INVENTION

### Field of the Invention

The disclosure relates to an exercise squat machine, more specifically, an exercise squat machine with a massaging roller that can be height adjusted and electronically powered.

### Description of Related Art

Exercise equipment includes rigs, stands, racks, and the like that support various exercise accessories. Typically, such exercise equipment enables a person to perform various exercises using weights, barbells, dumbbells, pull-up bars, dip stations, self-spotting bars, cables, ropes, elastic bands, and the like. Moreover, exercise equipment can support therapeutic apparatuses that allow users to stretch, to self-massage, and/or to apply pressure to tissue (e.g., for myofascial release). However, such exercise equipment is bulky and requires large spaces for use.

Exercise rollers may be used to exercise a variety of muscles. For example, abdominal rollers may be used to exercise abdominal muscles. Such an abdominal roller typically includes handles that are gripped by the user and a wheeled portion between the handles that can roll along a surface. However, conventional abdominal rollers are deficient in that the devices may be limited in functionality or may be uncomfortable and difficult to use for some users.

Hand-held massage rollers are well known to athletes and connoisseurs of exercise as a way to massage muscles such as the quadriceps, hamstrings, calves, and glutes. However, one persistent limitation of hand-held massage rollers is the limited range of muscles that can be massaged, i.e., it is difficult to massage a user's triceps when the user's arms are holding the massage roller. For example, it is exceedingly difficult, if not impossible, to use a hand-held massage roller to massage a majority of the muscles in a user's back.

The present disclosure satisfies a need which, notwithstanding the prolific development in the art, still exists in the field of exercise equipment and machines. As discussed above, the prior art does not teach a single exercise machine which combines features for abdominal exercises and squatting to provide a total body workout. Further, the exercise machines which might possibly be adapted for such a combination of exercises are of considerable size and weight or require a plurality of moving parts. Finally, hand-held massage rollers are cumbersome and limited in their range and applicability to a user's muscles.

### SUMMARY OF THE INVENTION

In one non-limiting embodiment or aspect of the present disclosure, a wall mounted roller device, having a roller having a body with an external surface circumferentially around an elongated bar, the bar having at least two attachment ends; and a base having a top sidewall, a bottom sidewall, and at least two parallel guide rails connected to the top sidewall and the bottom sidewall, the at least two parallel guide rails each having a plurality of attachment points; where the plurality of attachment points of the at least two parallel guide rails are configured to receive the at least two attachment ends of the bar such that the body of the roller is perpendicular to the at least two parallel guide rails.

In one embodiment, one of the at least two parallel guide rails includes an electric receiver and electric wiring internal to the at least two parallel guide rails.

In another embodiment, the plurality of attachment points of the at least two parallel guide rails and the at least two attachment ends of the bar are electrically connected such that a motor within the roller is powered.

In another embodiment, the body of the roller includes an internal motor which rotates the body of the roller about an axis of the elongated bar.

In another embodiment, a length of the body of the roller is greater than half of a length of the elongated bar.

In another embodiment, the body of the roller includes protrusions separated by indents.

In another embodiment, the body of the roller includes an internal motor which vibrates the body of the roller.

According to another embodiment, a wall mounted roller device, includes a roller including a body with an external surface circumferentially around an elongated bar, the elongated bar extending along a horizontal axis and having at least two attachment ends; an internal motor connecting the external surface of the body to the elongated bar; and a base including a top sidewall and a bottom sidewall, the top sidewall and the bottom sidewall extending parallel with the horizontal axis; and at least two parallel guide rails, the at least two parallel guide rails each extending parallel with a vertical axis and connected to the top sidewall and the bottom sidewall, the at least two parallel guide rails each having a plurality of attachment points; where the plurality of attachment points of the at least two parallel guide rails are configured to receive the at least two attachment ends of the bar such that the body of the roller is perpendicular to the at least two parallel guide rails and the internal motor rotates the body of the roller about the horizontal axis of the elongated bar.

In another embodiment, one of the at least two parallel guide rails comprises an electric receiver and electric wiring internal to the at least two parallel guide rails.

In another embodiment, the attachment points of the at least two parallel guide rails and the at least two attachment ends of the elongated bar are electrically connected such that the motor within the roller is powered.

In another embodiment, a length of the body of the roller is greater than half of a length of the elongated bar.

In another embodiment, the body of the roller includes protrusions separated by indents.

In another embodiment, the motor of the body of the roller vibrates the body of the roller.

In another embodiment, the attachment ends of the elongated bar are adjustably coupled to the attachment points of the at least two parallel guide rails.

In another embodiment, the attachment ends of the elongated bar extend past a distance between a surface of one of the at least two parallel guide rails and the other one of the at least two parallel guide rails.

According to another embodiment, a wall mounted roller device, includes a roller including an outer deformable layer surrounding an internal body, the internal body having a cavity; an axel, the axel extending through the cavity of the internal body, the axel coupled to the internal body with a plurality of bearings; and a backboard, the backboard having a first guide rail and a second guide rail, the first and second guide rail coupled with a horizonal rail, the first and second guide rail each having a plurality of attachment points, where the axel couples to the attachment points, the first and second guide rail each having a top portion and a bottom portion.

In another embodiment, one of the first and second guide rails comprises an electric receiver and electric wiring internal to one of the first or second guide rails.

In another embodiment, the attachment points, the first and second guide rails, and the axel are electrically connected such that a motor within the internal body is powered.

In another embodiment, each of the first and second guide rails have a vertical axis, the plurality of attachment points are along the vertical axis, the axel coupled to the attachment points such that the axel is parallel to the vertical axis.

In another embodiment, the axel is curved such that the roller extends past the first and second guide rails.

Other aspects of the present invention will be apparent to those skilled in the art upon reading the following description and claims. While the description and drawings are of a particular embodiment, other embodiments fall within the scope of the invention.

### BRIEF DESCRIPTION OF THE DRAWINGS

Other features, advantages, and details of the present invention will emerge on reading the following description of several embodiments of the invention given by way of illustration and not being limiting, said description being made with reference to the appended drawings.

FIG. 1 displays an isometric view of an example of a wall mounted roller hack squat device;

FIG. 2 displays a front view of an example of the wall mounted roller hack squat device;

FIG. 3 displays a side view of an example of the wall mounted roller hack squat device;

FIG. 4 displays a cutaway front view of a roller;

FIG. 5 displays an isometric view of the roller;

FIG. 6 displays an isometric view of an internal body of the roller;

FIG. 7 displays a bearing;

FIG. 8 displays an isometric view of a backboard;

FIG. 9 displays a partial cut away isometric view of an example of the wall mounted roller hack squat device;

FIG. 10 displays a sectional isometric view of an example of the wall mounted roller hack squat device; and

FIG. 11 displays an isometric view of an example of the wall mounted roller hack squat device.

### DESCRIPTION OF THE INVENTION

Characteristics of the present invention, as well as the methods of operation and functions of the related elements of structures and the combination of parts and economies of manufacture, will become more apparent upon consideration of the following description with reference to the accompanying drawings, all of which form a part of this Specification. It is to be expressly understood, however, that the drawings are for the purpose of illustration and description only, and are not intended as a definition of the limits of the invention. As used in the specification and the claims, the singular form of “a”, “an”, and “the” include plural referents unless the context clearly dictates otherwise. It is to be understood that the specific devices and processes illustrated in the attached drawings, and described in the following Specification, are simply exemplary embodiments of the invention. Hence, specific dimensions and other physical characteristics related to the embodiments disclosed herein are not to be considered as limiting.

Referring to the figures, wherein like numerals of reference designate like elements throughout the several views, the wall mounted roller hack squat device 100 can include a roller 200, an internal body 300, at least one bearing 400, an axel 500, and a backboard 600.

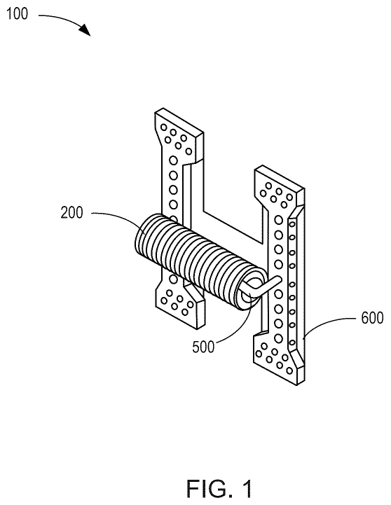

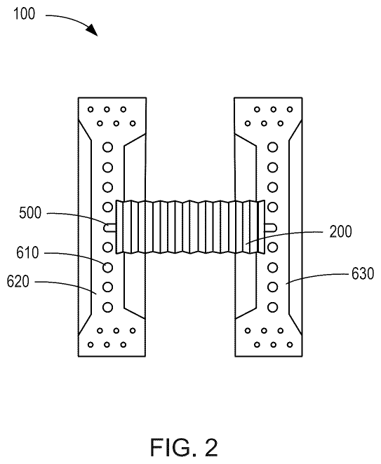

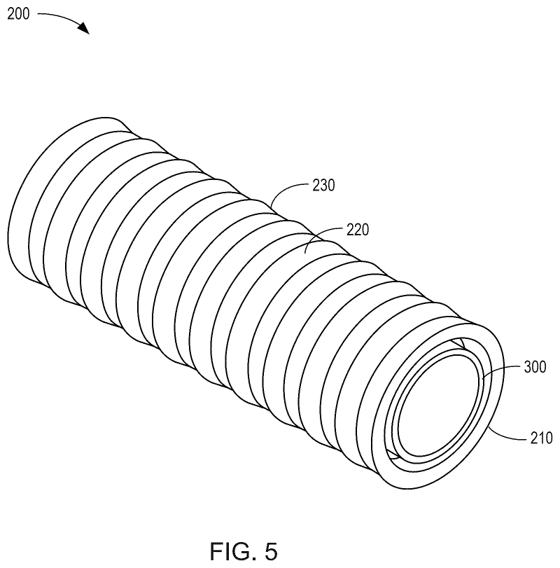

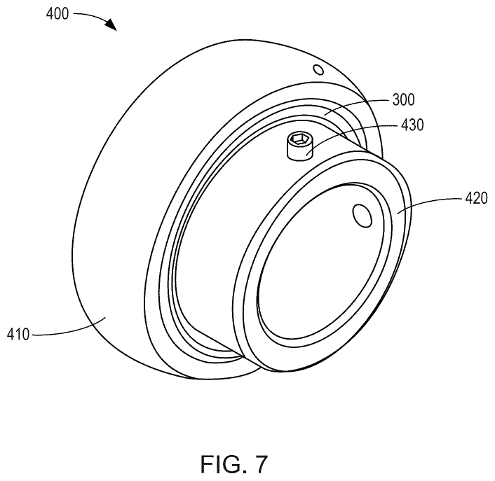

FIGS. 1-11 depict examples of the wall mounted roller hack squat device 100.

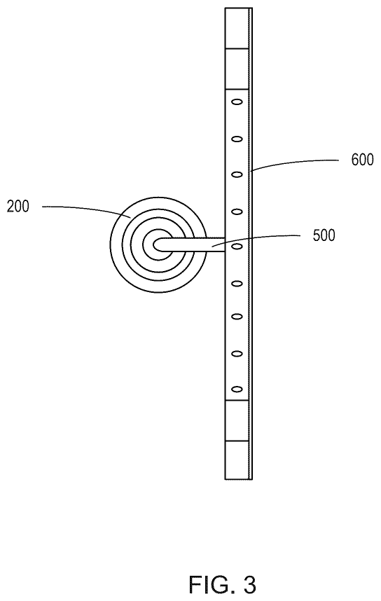

FIGS. 3-5 depict an example of the roller 200 including an external surface 210 and an internal body 300. Roller 200 and internal body 300 may be cylindrical in shape. The exercise roller 200 includes the external surface 210 surrounding the cylindrical core or internal body 300 for providing a surface-engaging perimeter of the exercise roller 200.

The foam material of external surface 210 may be wrapped, overmolded, stretched, or adhered around the internal body 300, and glued or adhered to the internal body 300 using any suitable method and materials. Overmolding may also be suitable for forming the external surface 210 such that the foam material may be overmolded to the internal body 300. If materials other than foam are used, other manufacturing methods and materials may be used to secure the external surface 210 to the internal body 300. The materials used for the exercise roller 100 may be lightweight and rigid materials that are selected to facilitate transportation and use of the device while still providing support. The materials may also be selected to facilitate manufacturing. The arrangement of the axel 500, the internal body 300, and the exercise roller 200, and the use of the foam material for the external surface 210 may be particularly advantageous in massaging muscles as compared with conventional rollers.

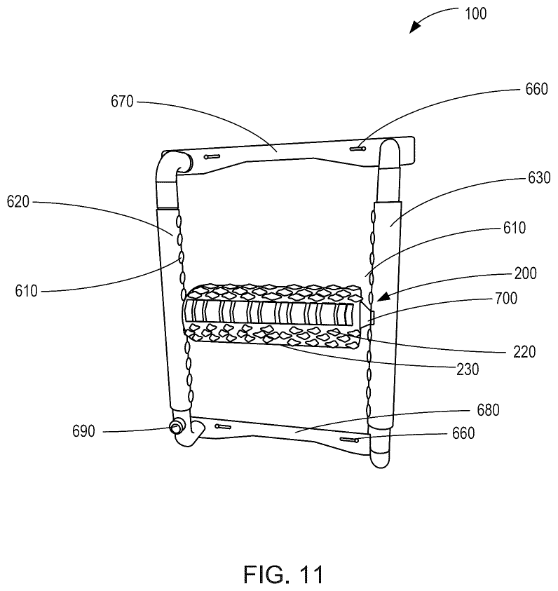

In another embodiment, the external surface 210 has a different repeating pattern as compared with the pattern shown in FIGS. 1-5. In this embodiment, as shown in FIG. 11, the pattern of the external surface 210 includes protrusions 220 which may be formed as ridges, pyramids, pillars, bumps, etc. that are separated by indents 230. Many other protrusion shapes may be possible for the pattern, such as cones, rounded protrusions and squared protrusions. The repeating pattern as shown, may also include coiled portions (not shown) which are arranged in a set and separated from an adjacent set of coiled portions by a smooth portion. It is understood that the above-described and depicted patterns of the external surface 210 material are provided as non-limiting examples and many other patterns other than the patterns shown in FIGS. 1-11 may be suitable.

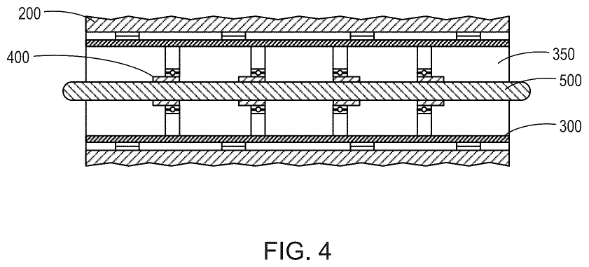

FIG. 4 depicts a cross-section of an embodiment of the roller 200 with the axel 500 displaying an exemplary embodiment of the internals of the roller 200 in more detail. The internal body 300 and the external surface 210 may be fixed for rotation such that the roller 200 is rolled around the axel 500, by the user moving the roller 200. Accordingly, the external surface 210 may extend along an entire shoulder span of the user. The External surface 210 may extend along the whole axel 500, or part of the axel 500. The axel 500 is configured to extend through the internal body 300 and the bearings 400 along the entire length L of the internal body 300. It is noted that the roller 200 may include an internal cavity 350 of the internal body 300. The internal cavity 350 may include spacing between the inner surface of the internal body 300 and the axel 500. The internal cavity 350 spans axially along the entire length L of the internal body 300 or within each end of the internal body 300. The internal body 300 may be formed of any suitable material, such as an extruded rigid plastic material and may have a plurality of extruded ribs for strength. For example, polyvinyl chloride may be a suitable material. It is understood that these materials are provided as non-limiting examples and that many other materials may be suitable.

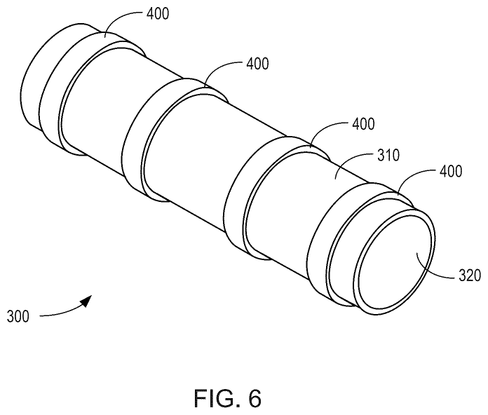

Any number of bearings or retainers 400 may be used to axially locate in the internal body 300 on an elongated bar or axel 500 and facilitate assembly of the components. For example, in FIG. 6.-7., the retainers 400 may include at least one of a sleeve bearing, a roller bearing, a ball bearing, or a sintered bearing 410. The retainers 400 may include at least one of a retaining ring 420, a retaining pin 430, a retaining screw, and a retaining nut. It will be understood that the above-described examples of the bearings 410 and the retainers 400 are provided as non-limiting examples, and that other types of bearings 410 and retainers 400 may be suitable. The bearings 410 and the retainers 400 may be axially interposed between an outer surface 310 of the internal body 300 and the external surface 210. Additional retainers 400 and/or bearings 410 may be added if other components are attached to the exercise roller 200. The bearings 410 and retainers 400 may be formed of any suitable material, such as a metal material. For example, the bearings 410 and retainers 400 may be made of steel, however it is understood that other metal materials may be suitable.

FIG. 4 further depicts an embodiment of the axel 500 coupled to the internal body 300 with multiple bearings 400. The axel 500 may extend through a cavity 320 of the internal body 300. As depicted in the embodiment of FIG. 4, the axel 500 may be hollow, however the axel 500 may alternatively be solid. The axel 500 may be formed of any suitable rigid material, such as a metal. For example, the axel 500 may be formed of aluminum. It is understood, however, that these materials of the axel 500 are provided as non-limiting examples and that other suitable rigid materials may be applicable. The axel 500 may be straight or include curves. As depicted in the embodiments of FIGS. 1-3 and 9-10, the ends of the axel 500 may be angled or curved and include attachment ends 520. The attachment ends 520 may connect with attachment points 610 of the backboard 600. The attachment ends 520 may couple by sliding into the attachment points 610 or fitting and connecting with any connecting means. The attachment ends 520 may slide or extend into or through the attachment points 610. Such attachment supports the roller 200 and prevents the axel 500 from disconnecting from the backboard 600 when not so desired. The axel 500 may be angled or curved such that the roller 200 extends outwards away from the backboard 600.

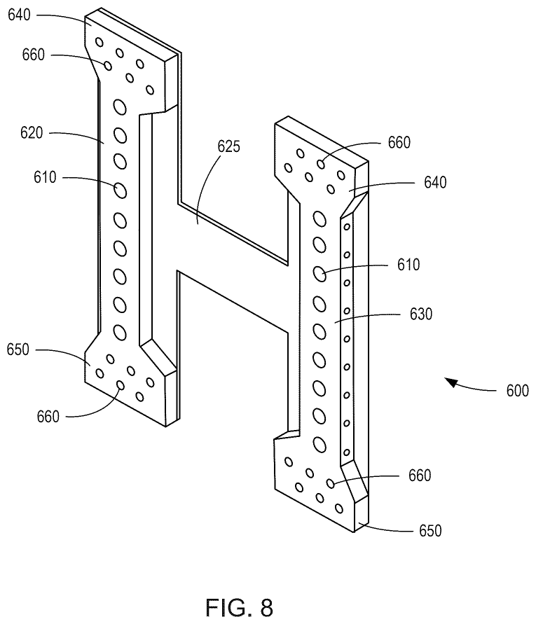

FIGS. 8-10 depict an embodiment of the backboard 600 and the wall mounted roller hack squat device 100. The backboard 600 may include a first guiderail 620 and a second guiderail 630 arranged parallel to one another and extending in the vertical direction. The first guiderail 620 and the second guiderail 630 are coupled by a horizontally extending rail 625. The first guiderail 620 and the second guiderail 630 may include attachment points 610 arranged vertically. The attachment points 610 are arranged vertically such that the attachment points 610 are spaced at even heights such that when the attachment ends 520 of the axel 500 are coupled to the attachment points 610, the horizontal height of the axel 500 and roller 200 is at a desired height. The first guiderail 620 and the second guiderail 630 may each include a top end 640 and a bottom end 650. The top end 640 and the bottom end 650 may have a greater width than the middle sections of the first guiderail 620 and the second guiderail 630. The top end 640 and the bottom end 650 may further include attachment points 610 and/or mounting points 660. The mounting points 660 may be arranged to provide multiple attachment locations for the backboard 600 to a wall.

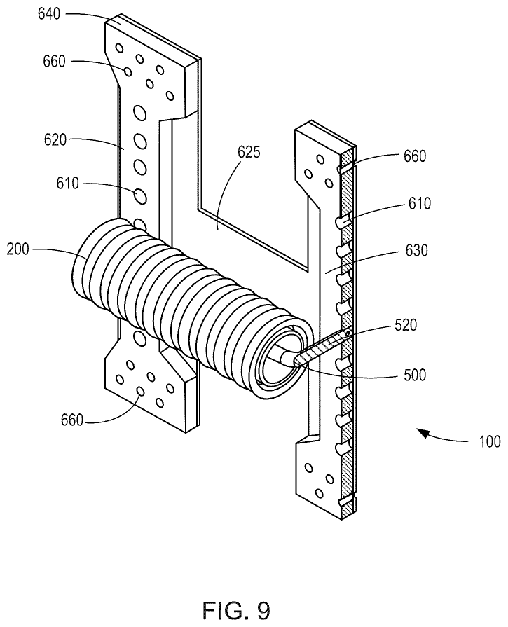

FIG. 9 depicts the embodiment of the wall mounted roller hack squat device 100 having the attachment ends 520 of the axel 500 coupled to the attachment points 610 of the backboard 600. The attachment ends 520 are coupled with the attachment points 610 such that roller 200 and axel 500 are horizontally arranged. Another description may include that the attachment ends 520 are coupled with attachment points along the each of the first guiderail 620 and the second guiderail 630.

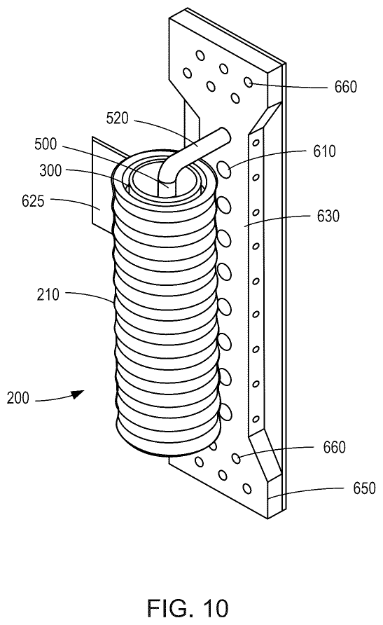

FIG. 10 depicts an embodiment of the wall mounted roller hack squat device 100 having the attachment ends 520 of the axel 500 coupled to the attachment points 610 of the backboard 600. The attachment ends 520 are coupled with the attachment points 610 such that the roller 200 and axel 500 are vertically arranged. Another description may include that the attachment ends 520 are coupled with attachment points along one of the first guiderail 620 or the second guiderail 630.

FIG. 11 depicts another embodiment of the wall mounted roller hack squat device 100 having a straight axel 500. The backboard 600 may include a top sidewall 670 and a bottom sidewall 680 connecting to the first guiderail 620 and the second guiderail 630. The first guiderail 620 and the second guiderail 630 may be cylindrical in shape and extrude from the top sidewall 670 and the bottom sidewall 680 such that the first guiderail 620 and the second guiderail 630 include top and bottom curved ends. The attachment points 610 of the first guiderail 620 may face inward towards the attachment points 610 of the second guiderail 630. The attachment ends 520 of the axel 500 may be coupled to the attachment points 610 while the axel 500 is straight or lacks any bends. In this embodiment, the roller 200 and axel 500 are in between the first guiderail 620 and the second guiderail 630.

In another embodiment, a motor 700 may be internal to the internal body 300 or axel 500 and within the cavity 350 The motor 700 may be powered to rotate or spin the roller 200. The motor 700 may also vibrate or shake. The motor 700 may be electronically coupled to a power source through the electric connection from the attachment ends 520 of the axel 500 to the attachment points 610 of the backboard 600. As shown in FIG. 11, the backboard 600 may have an electronic plug 690. A cord or electric connection may extend from plug 690, providing power from an external source to the motor 700.

The exercise roller may be used for a variety of exercises, including but not limited to squat exercises. Advantageously, in the embodiment in which the material of the cover is foam, the exercise roller is configured to provide improved comfort and support during rolling of the cylindrical core along a surface due to the material of the foam cover, and the density of the inner core and the foam. For example, using the foam cover may be particularly advantageous in preventing muscle recovery as compared with conventional exercise or abdominal rollers. In exemplary applications, the roller may be used to provide a deep tissue or soft tissue massage.

What is claimed is:

1. A wall mounted roller device, comprising:
a roller having a body with an external surface circumferentially around an elongated bar, the bar having at least two attachment ends; and
a base having a top sidewall, a bottom sidewall, and at least two parallel guide rails connected to the top sidewall and the bottom sidewall, the at least two parallel guide rails each having a plurality of attachment points;
wherein the plurality of attachment points of the at least two parallel guide rails are configured to receive the at least two attachment ends of the bar such that the body of the roller is perpendicular to the at least two parallel guide rails.

2. The wall mounted roller device of claim 1, wherein one of the at least two parallel guide rails comprises an electric receiver and electric wiring internal to the at least two parallel guide rails.

3. The wall mounted roller device of claim 2, wherein the plurality of attachment points of the at least two parallel guide rails and the at least two attachment ends of the bar are electrically connected such that a motor within the roller is powered.

4. The wall mounted roller device of claim 1, wherein the body of the roller includes an internal motor which rotates the body of the roller about an axis of the elongated bar.

5. The wall mounted roller device of claim 1, wherein a length of the body of the roller is greater than half of a length of the elongated bar.

6. The wall mounted roller device of claim 1, wherein the body of the roller includes protrusions separated by indents.

7. The wall mounted roller device of claim 1, wherein the body of the roller includes an internal motor which vibrates the body of the roller.

8. A wall mounted roller device, comprising:
a roller comprising:
a body with an external surface circumferentially around an elongated bar, the elongated bar extending along a horizontal axis and having at least two attachment ends;
an internal motor connecting the external surface of the body to the elongated bar; and
a base comprising:
a top sidewall and a bottom sidewall, the top sidewall and the bottom sidewall extending parallel with the horizontal axis; and
at least two parallel guide rails, the at least two parallel guide rails each extending parallel with a vertical axis and connected to the top sidewall and the bottom sidewall, the at least two parallel guide rails each having a plurality of attachment points;
wherein the plurality of attachment points of the at least two parallel guide rails are configured to receive the at least two attachment ends of the bar such that the body of the roller is perpendicular to the at least two parallel guide rails and the internal motor rotates the body of the roller about the horizontal axis of the elongated bar.

9. The wall mounted roller device of claim 8, wherein one of the at least two parallel guide rails comprises an electric receiver and electric wiring internal to the at least two parallel guide rails.

10. The wall mounted roller device of claim 9, wherein the attachment points of the at least two parallel guide rails and the at least two attachment ends of the elongated bar are electrically connected such that the motor within the roller is powered.

11. The wall mounted roller device of claim 8, wherein a length of the body of the roller is greater than half of a length of the elongated bar.

12. The wall mounted roller device of claim 8, wherein the body of the roller includes protrusions separated by indents.

13. The wall mounted roller device of claim 8, wherein the motor of the body of the roller vibrates the body of the roller.

14. The wall mounted roller device of claim 8, wherein the attachment ends of the elongated bar are adjustably coupled to the attachment points of the at least two parallel guide rails.

15. The wall mounted roller device of claim 8, wherein the attachment ends of the elongated bar extend past a distance of between a surface of one of the at least two parallel guide rails and the other one of the at least two parallel guide rails.

16. A wall mounted roller device, comprising:
a roller comprising:
outer deformable layer surrounding an internal body, the internal body having a cavity;
an axel, the axel extending through the cavity of the internal body, the axel coupled to the internal body with a plurality of bearings; and
a backboard, the backboard having a first guide rail and a second guide rail, the first and second guide rail coupled with a horizonal rail, the first and second guide rail each having a plurality of attachment points, wherein the axel couples to the attachment points, the first and second guide rail each having a top portion and a bottom portion.

17. The wall mounted roller device of claim 16, wherein one of the first and second guide rails comprises an electric receiver and electric wiring internal to one of the first or second guide rails.

18. The wall mounted roller device of claim 17, wherein the attachment points, the first and second guide rails, and the axel are electrically connected such that a motor within the internal body is powered.

19. The wall mounted roller device of claim 16, wherein each of the first and second guide rails have a vertical axis, the plurality of attachment points are along the vertical axis, the axel coupled to the attachment points such that the axel is parallel to the vertical axis.

20. The wall mounted roller device of claim 16, wherein the axel is curved such that the roller extends past the first and second guide rails.
